(19) United States
(12) Patent Application Publication
(10) Pub. No.: US 2025/0061611 A1
(43) Pub. Date: Feb. 20, 2025

(54) GEO-LOCATION DEPENDENCY MATRIX WITH AUGMENTED REALITY (AR)

(71) Applicant: INTERNATIONAL BUSINESS MACHINES CORPORATION, ARMONK, NY (US)

(72) Inventors: Zachary Heinz Thaxton, Austin, TX (US); Anthony Joseph Arcuri, Williamson, TX (US); Bianca Isabel Perez, Austin, TX (US); Abhishek Shrivastava, Cedar Park, TX (US)

(21) Appl. No.: 18/451,992

(22) Filed: Aug. 18, 2023

(51) Int. Cl. G06T 11/00; G06T 7/70

(52) U.S. Cl. CPC G06T 11/00; G06T 7/70

(57) ABSTRACT

Systems and methods are provided for establishing an AR infrastructure in a defined space. Physical objects in the defined space are identified using proximity technology for inclusion in a geo-location dependency matrix. A plurality of physical identifying characteristics associated with the physical objects is collected. A logical relationship between the physical object and the other physical objects is determined. The physical objects are connected by determined logical relationships. The geographical location and orientation of the physical object within the defined space are processed, and an activity is associated with the physical object.

### BACKGROUND

This invention relates generally to computer systems, and more particularly to augmented reality.

Computing installations, for example, those comprising networking and server equipment, are complex and house a variety of hardware devices along with the cabling connecting them. For safety and efficiency, a technician should be proficient in identifying the hardware and cabling connections so that outages can be resolved by quickly locating the point of failure. However, computing environments are not uniform in size, design, layout, vendor providing the computer hardware, or various environmental characteristics such as temperature and power. Additionally, a technician assigned to troubleshoot an outage may not be the usual engineer who is familiar with the environment or may be an inexperienced engineer.

It would be advantageous to provide an augmented reality solution to assist the technician in real-time by interpreting visual information and its relationship to the physical and logical hardware to quickly orient and guide the work problem resolution.

### SUMMARY

A method is provided comprising processing a relationship of a physical object to other physical objects in a defined space, processing a geographical location and orientation of the physical object within the defined space using proximity technology, and associating an activity with the physical object, comprising displaying the physical object as an overlay in an AR-enabled device, integrating process steps for performing the activity with the overlay in the AR-enabled device, managing the sequence of the process steps, and recording completion of each step. The physical object comprises metadata, which includes physical images, schematic references, part descriptors, and the interfaces to and between the other physical objects in the defined space. Integrated physical and logical association maps are created.

Embodiments are further directed to computer systems and computer program products having substantially the same features as the above-described computer-implemented method.

### BRIEF DESCRIPTION OF THE SEVERAL VIEWS OF THE DRAWINGS

FIG. 1 illustrates the operating environment of a computer server embodying a system for creating a geo-location dependency matrix with augmented reality (AR);

FIG. 2 illustrates an example defined space where embodiments of the present invention can be practiced;

FIG. 3 illustrates an example display of a logical AR overlay of a computing device;

FIG. 4 illustrates an example display of a logical-to-physical AR overlay of a computing device;

FIG. 5 is a block diagram illustrating establishing an AR infrastructure in accordance with the present disclosure;

FIG. 6 is a block diagram illustrating associating a logical-to-physical computing device in the AR system in accordance with the present disclosure; and

FIG. 7 is a block diagram illustrating a use case of performing an activity using an AR overlay in accordance with the present disclosure.

### DETAILED DESCRIPTION OF THE INVENTION

For safety and efficiency, a technician performing an activity in the defined space of a computer room should be proficient in identifying the computer hardware and cabling connections so that outages can be resolved by quickly locating the point of failure.

Safety in this regard refers not only to preventing personal injury accidents. Safety also refers to understanding the relationships between the computer hardware and their connections to prevent accidentally powering down a computing device or disconnecting an incorrect cable.

Efficiently, in this context, refers to the ability to quickly locate and resolve specific issues originating from an outage somewhere in the computing environment. The results of various customer case studies indicate an average planned outage may cost approximately $6747.00 per minute, while an unplanned outage may cost 35% more. Additionally, some customer environments, for example, financial institutions and government institutions, are highly regulated or require heightened security. Often in these cases, a technician is cleared to work only on a specific computing device or to work only in a specific area and is escorted and monitored while there. In these highly restrictive environments, it is advantageous to locate the source of the outage quickly and accurately, without undue trial and error.

However, computing environments are not uniform in size, design, layout, purpose, the vendor providing the computer hardware, or various environmental characteristics such as temperature and power. It is possible that a computing environment comprises more than one computer room that spans multiple floors or geographic locations. These computing environments may be logically connected through networks. Additionally, a technician assigned to troubleshoot an outage may not be the usual engineer and may have limited experience or familiarity with the computing environment. As a result, the likelihood of quickly, independently, and successfully completing the work request without errors is low.

Some current solutions to address the issues of safety and efficiency implement a digital twin architecture to approximate the computing environment layout at a macro level. The digital twin is a virtual model designed to accurately reflect a physical object. However, the costs to maintain the virtual model can be prohibitive not only in the time required but also in the amount of computing and data storage resources. For example, adding a new twin impacts the virtual model, which must be rebuilt to reflect the modified physical environment. In contrast, adding a node using embodiments of the present invention simultaneously identifies the physical location of the node and creates a QR/RFID tag that can be printed and attached to it. The physical node and its logical associations are now viewable through an AR-enabled device.

It would be advantageous to provide an AR solution to assist the technician in real-time by interpreting and presenting visual information as a series of selectable overlays in an AR-enabled device. The technician can select one or more of the overlays to show physical hardware and its logical relationships to other physical hardware to orient and guide the problem resolution. As will be described further with reference to the Figures, embodiments of the present invention establish a key pair that relates the geographic location to metadata, where location is the physical 3D position in a room and the metadata is descriptive data about the physical object at that location. The physical portion of the key pair data is marked using RFID, QR code, or similar tags. The physical portion of the key pair data is organized as a graph of logical relationships which are their interdependencies. The AR-enabled device is one that includes a camera, microphone, speaker, and screen such as a smartphone, tablet, or laptop, and that is enabled with embodiments of the present invention as an AR application.

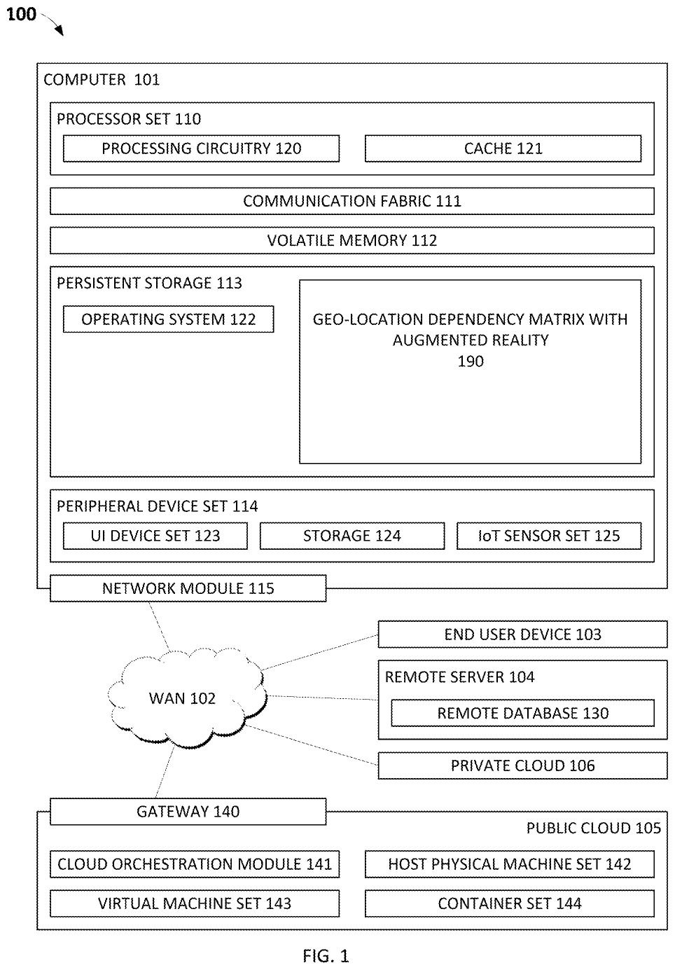

Beginning now with FIG. 1, an illustration is presented of the operating environment of a networked computer, according to an embodiment of the present invention.

Computing Environment 100 contains an example of an environment for the execution of at least some of the computer code involved in performing the inventive methods, such as a geo-location dependency matrix with augmented reality 190 (AR system). In addition to block 190, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI), device set 123, storage 124, and Internet of Things (IoT) sensor set 125), and network module 115. Remote server 104 includes a remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation on computing environment 100, a detailed discussion is focused on a single computer, specifically Computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, the processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct the performance of the inventive methods. In computing environment 100, at least some of the instructions for performing the inventive methods may be stored in block 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows Computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, an administrator that operates computer 101), and may take any of the forms discussed above in connection with computer 101. For example, EUD 103 can be the external application by which an end user connects to the control node through WAN 102. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to the public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after the instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public Cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

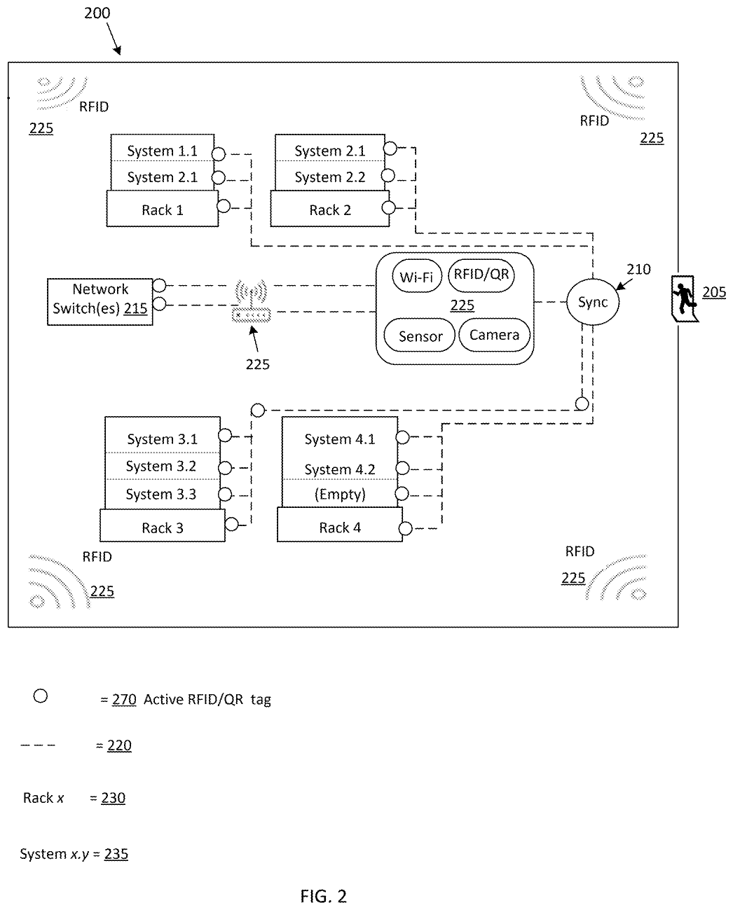

FIG. 2 depicts an example defined space where embodiments of the present invention can be practiced.

The defined space, shown as computer room 200, is scaled and mapped to the AR system 190. An AR-enabled device is oriented within the space by triangulating with a sync point and can readily recognize the larger objects in computer room 200 based on proximity and physical characteristics. One or more logical views of computer room 200 can be selected for display on the AR-enabled device.

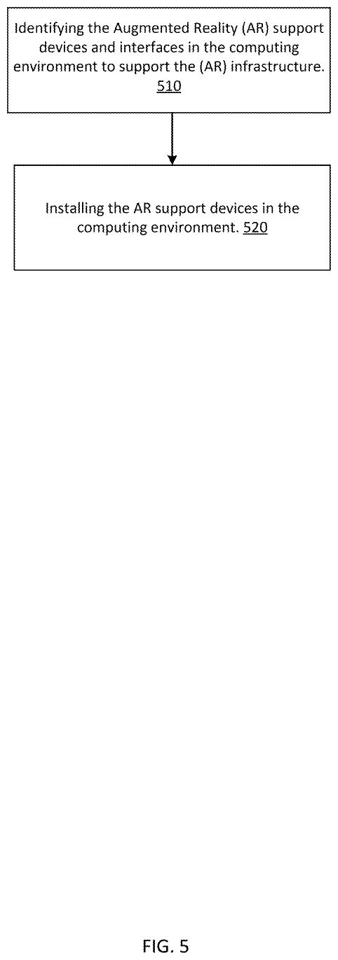

A sync point 210 and RFID/QR/Wi-Fi/Sensors 225 (proximity technology) are used to triangulate the location of the AR-enabled device, associating that location with computer hardware (cables and computing equipment) in near proximity as they are passively scanned. This higher-level mapping layer provides a macro-orientation of the computer room 200 that will be further refined with the sync point 210 and QR/RFID tags 270 that are placed on devices. The QR/RFID tags 270 record additional metadata that will be associated with the architecture and connectivity of the devices. As will be described below with reference to FIG. 5, the QR/RFID tags 270 identify a device's point in space by an (x, y, z) coordinate and a set of metadata that the AR system 190 uses to create a geo-location dependency matrix graph, with views that can be selected as one or more overlays in the AR-enabled device.

As shown in FIG. 2, computer room 200 includes four racks, racks “1” through “4.” Each rack includes one or more systems, noted as rack.server. For example, rack “4” 230 includes system “4.1” 235 and system “4.2” 235. Here, “system” generically refers to any type of computer equipment, such as a server, or disk array cabinet, that can be housed in a rack. The network switch(es) 215 is shown standalone but may be included in a rack.

The RFID/QR/Wi-Fi/Sensors 225 are input/output network devices, such as Wi-Fi hotspots, various motion-detecting sensors, cameras, and RFID/QR readers. The AR-enabled device detects a nearby active RFID/QR/Wi-Fi/Sensor 225 and identifies the particular computing device to which the sensor is attached. RFID/QR/Wi-Fi/Sensors 225 are placed on physical cables that are contained within cable trays either under the computer room 200 floor or above the computer room 200 ceiling. Active QR/RFID tags 270 are placed on the cable trays but can also be placed on the individual cables to mark the physical paths along which the cables are installed.

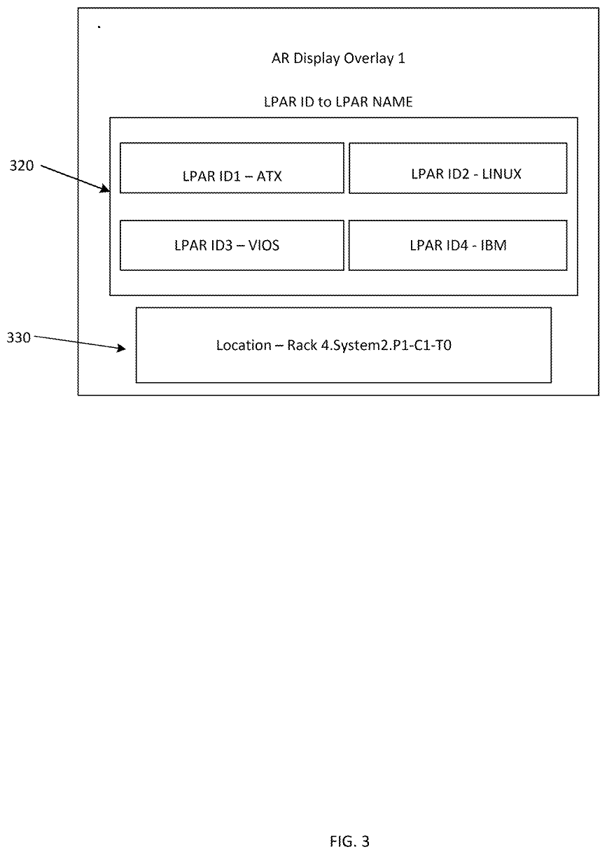

FIG. 3 illustrates how an exemplary logical AR overlay of the system “4′2” 235 of the rack “4” 230 may be displayed.

This AR overlay illustrates a cross-reference of logical partition (LPAR) identifiers (ID) to LPAR NAME of the system “4.2” 235 in rack “4” 230 of FIG. 2. As shown, the system “4.2” 235 includes four LPARs 320, having LPAR ID1, LPAR ID2, LPAR ID3, and LPAR ID4. The LPARs are further identified by the names ATX, LINUX, VIOS, and IBM, respectively. The location 330 identifies the physical location of the system “4.2” 235 within rack “4” 230. This overlay can be constructed in response to the AR system 190 receiving from the AR-enabled device a target location to display. As a response, the AR system 190 retrieves from the geo-location dependency matrix the physical 3D position in the room of the target location and constructs the overlay of logical relationships based on the associated metadata. Alternatively, a technician can point the AR-enabled device at a QR/RFID tag 270 of interest. In response, the AR system 190 locates the QR/RFID tag 270 in the geo-location dependency matrix and constructs the overlay of logical relationships using that location as a starting point.

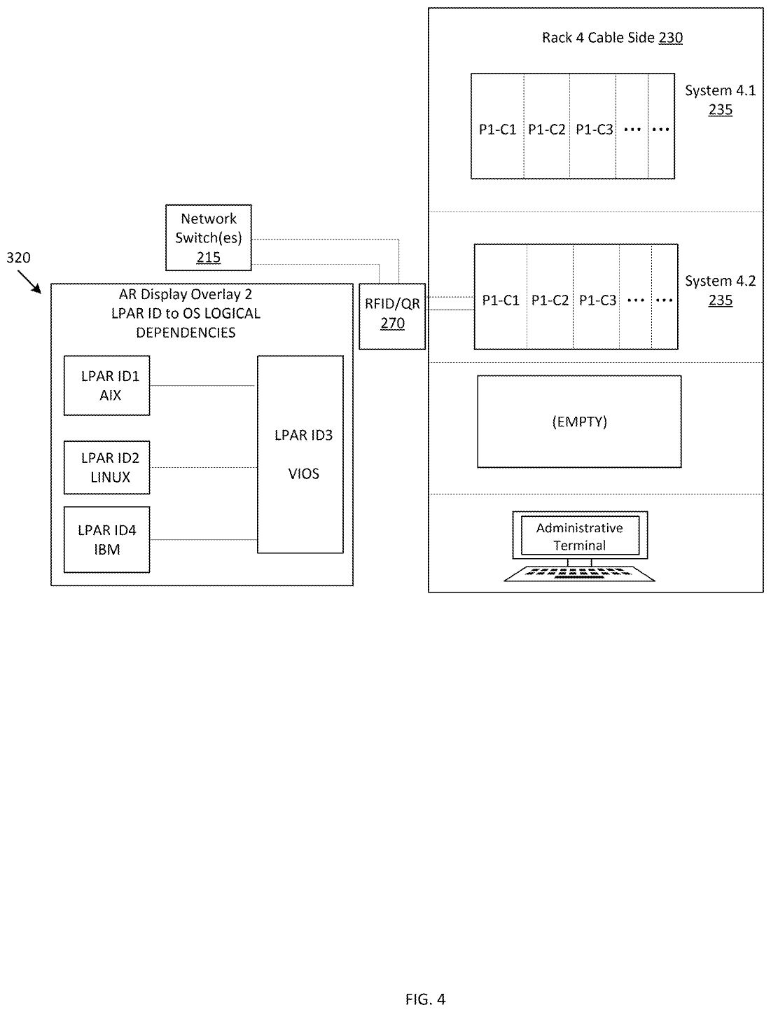

FIG. 4 illustrates how an exemplary logical-to-physical AR overlay of the system “4.2” 235 in rack “4” 230 may be displayed. The logical-to-physical AR overlay can be constructed in an analogous manner to that in FIG. 3

Where FIG. 3 shows the physical locations of the four LPARs 320, FIG. 4 shows their logical relationships. For example, LPAR ID3 (VIOS) is a virtual I/O server that provides basic access among LPARs to physical computing resources on a shared basis, thereby making LPAR ID1, LPAR ID2, and LPAR ID4 dependent upon LPAR ID3, as shown here.

The AR overlay in FIG. 4 also shows the cable locations from the back side of the rack “4” 230 (FIGS. 2-3). As an example, this AR overlay will guide a technician using the AR enabled device to the cable P1-C1 location in system “4.2” 235. QR/RFID tags 270, only one of which is shown, highlight the precise path between the origin of the cable in switch(es) 215 to the end of the cable in system “4.2” 235 in the AR enabled device overlay.

FIG. 5 illustrates a block diagram for establishing an AR infrastructure in accordance with the present disclosure.

Establishing computer room 200 for the AR system 190 comprises identifying and installing the AR supporting devices, such as the RFID/QR/Wi-Fi/sensors 225 at strategic locations to enable optimal communication among the devices. At least one sync point 210 is installed, preferably near each computer room 200 entrance, so that the technician 205 carrying the AR-enabled device is quickly oriented to the computer room. An identifying QR/RFID tag 270 is attached to each rack, device, cable, and other room elements of interest for the AR system 190 to track. Cameras may be employed in addition to the RFID/QR/Wi-Fi/sensors 225 to assist in identifying the relative position of devices and the technician 205 when engaging with a computing device or cable of interest, as when performing an activity. The RFID/QR/Wi-Fi/sensors 225 are preferably placed in the computer room to have a strong line of sight to the technician 205 and to the sync point 210 (510, 520).

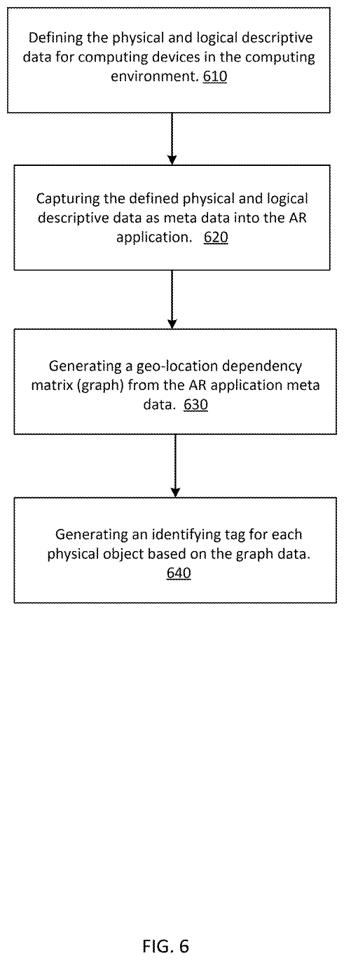

FIG. 6 is a block diagram illustrating associating a logical-to-physical computing device in AR system 190 in accordance with the present disclosure.

Both physical and logical objects of computer room 200 and their association with other devices and locations in the computer room are well-defined to strengthen their association and to provide input to the AR system 190 (610). The physical objects of the network and devices are defined by the enterprise according to the particular requirements of the enterprise, such as architectures, layouts, and where there are multiple computer rooms, and their relationships to each other. The enterprise also establishes its naming conventions and descriptive data, depending on what the enterprise determines it needs to clearly recognize the physical object and its usage without additional cross-reference documentation.

For example, a device type may be a server, disk storage array, or network switch. Associated descriptive data may include a serial number, physical room/rack location, and vendor. Similarly, a connection type can be defined as a cable, with additional associated descriptive data including type of cable (ethernet, power, USB), color, relative position (below floor, above), and the physical endpoint locations. Each physical object entry can further include a free-form descriptive text field.

The physical object descriptive data can be entered at any computing device having network access to the AR system 190. Additionally, data can be ingested from the registry that a hardware management console maintains of computer equipment to which it is attached (620).

As it is entered, the AR system 190 constructs a geo-location dependency matrix as a graph of the physical objects, with each physical object being a node, and the logical interdependencies being edges. The graph may be constructed using any format and language suitable for the purpose, such as JavaScript Object Notation (JSON), which is a language-independent data format. The data may be stored in a highly flexible and simple format, such as a JSON database, and that storage may be in a cloud, either hybrid, public, or private (630).

For each physical object, the AR system 190 prints a QR/RFID tag 270 for placement on the physical object. The QR/RFID tag 270 encapsulates the object's descriptors (metadata) for association with other elements in the graph (the logical relationships). The QR/RFID tag 270 includes the physical location, i.e., the geographical location, of the physical object's point in space in an x, y, z coordinate format. For example, as technician 205 enters computer room 200, the AR-enabled device triangulates with sync point 210 to establish the physical point in space of the AR-enabled device. Walking ahead or to the left or right may be considered proceeding along the “x” or “y” coordinate. The “z” coordinate indicates a distance above the floor, for example, a cable connected to a device that is physically housed at the top location of a physical rack.

In addition to entering physical object data, the AR system 190 provides an interface to scan and update the existing QR/RFID tags 270. In this maintenance mode, the camera on the AR-enabled device is pointed at a QR/RFID tag 270, which is scanned for verification against the stored graph data. If the QR/RFID tag 270 is in an unexpected location or displays problematic output, the QR/RFID tag 270 is marked in the AR system 190 for follow-up. For example, the QR/RFID tag 270 may have become physically damaged, or one of the RFID/QR/Wi-Fi/Sensors 225 may need to be updated to receive the most current information.

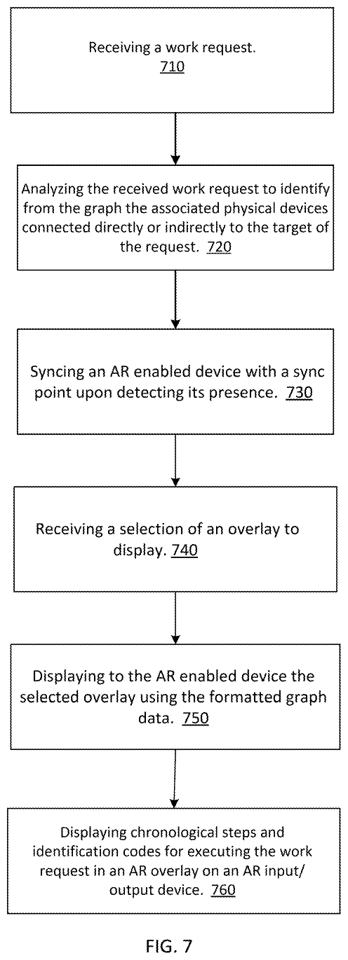

FIG. 7 is a block diagram illustrating a use case of performing an activity using an AR overlay in accordance with the present disclosure.

This example contemplates performing an activity in computer room 200 where the AR system 190 is implemented. The AR system 190 makes available one or more application programming interfaces (API) through which an enterprise's service maintenance ticket application exchanges information with the AR system 190. Another API can allow access to various documentation databases, such as those containing engineering specifications that technician 205 can reference for service procedures.

At 710, the AR system 190 receives a work request for execution.

At 720, the AR system 190 analyzes the work request to identify the physical nodes (device(s), card(s), port(s), cable(s), etc.) involved. These may be identified in the work request, for example, by serial number, QR/RFID tag 270, connectivity associations, or other identifiers as defined by the enterprise. The AR system 190 extracts the physical node data from its graph and builds the graph of the logical edges connecting those physical nodes.

At 730, when technician 205 enters computer room 200, AR system 190 detects the presence of the AR-enabled device and syncs it with sync point 210, usually located near the entrance.

At 740, the AR system 190 presents technician 205 with the ability to select at least one overlay. The enterprise can customize the number and format of the overlays depending on the data and the requirements for its display. For example, FIG. 3 illustrates how a simplified overlay is created from the stored graph node and metadata data using graph theory. FIG. 4 illustrates expanding upon the overlay of FIG. 3 as a virtualized map using a particular scanned QR code as the starting point. Another overlay (not shown) can be activated in maintenance mode to show if the scanned QR code was marked for follow-up, as in the passive maintenance mode described earlier with reference to FIG. 6.

At 750, the AR system 190 displays to the AR-enabled device the selected overlay using the formatted graph data.

At 760, the AR system 190 displays to the AR-enabled device the order of process steps to perform the activity, along with their associated identification and verification codes. This information acts as an interactive reference and checklist where technician 205 can indicate the success or failure of each step. In an embodiment, technician 205 can orally interact with the AR system 190 through a microphone and speaker on the AR-enabled device to request more granularity for the execution of a step, for example, requesting documentation or engineering specifications from one or more documentation databases using the provided API. The AR-enabled device can additionally receive spoken notes or verification of a step's completion through the microphone.

As may be used herein, the terms “substantially” and “approximately” provide an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as certain significant functions are appropriately performed. Similarly, flow diagram blocks may also have been arbitrarily defined herein to illustrate certain significant functionality.

To the extent used, the flow diagram block boundaries and sequence could have been defined otherwise and still perform certain significant functionality. Such alternate definitions of both functional building blocks and flow diagram blocks and sequences are thus within the scope and spirit of the claims. One of average skill in the art will also recognize that the functional building blocks, and other illustrative blocks, modules, and components herein, can be implemented as illustrated or by discrete components, application-specific integrated circuits, processors executing appropriate software, and the like, or any combination thereof.

One or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from Figure to Figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer-readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in the form of a solid-state memory, a hard drive memory, a cloud memory, a thumb drive, server memory, computing device memory, and/or other physical medium for storing digital information. A computer-readable memory/storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

While particular combinations of various functions and features of one or more embodiments have been expressly described herein, other combinations of these features and functions are likewise possible. The present disclosure is not limited by the particular examples disclosed herein and expressly incorporates these other combinations.

What is claimed is:

1. A method comprising:
processing a relationship of a physical object to other physical objects in a defined space;
processing a geographical location and orientation of the physical object within the defined space; and
associating an activity with the physical object.

2. The method of claim 1, wherein the physical object comprises metadata, the metadata comprising physical images, schematic references, part descriptors, and interfaces to and between the other physical objects.

3. The method of claim 1, wherein processing the geographic location and orientation of the physical object comprises systematic capture by existing proximity technology to develop integrated physical and logical association maps.

4. The method of claim 3, wherein the proximity technology comprises cameras, RFID tags, QR codes, and augmented reality (AR) devices.

5. The method of claim 1, wherein the associating the activity with the physical object further comprises:
displaying the physical object as an overlay in an AR enabled device;
integrating process steps for performing the activity with the overlay in the AR enabled device:
managing a sequence of the process steps; and
recording a completion of each step.

6. The method of claim 3, wherein an AR-enabled device integrates the physical and logical association maps, additional documentation, and a process sequence for an activity as display elements, and wherein each display element is separately selectable.

7. The method of claim 1, further comprising:
upon detecting a presence of an AR-enabled device, syncing the AR-enabled device with a sync point in the defined space.

8. The method of claim 1, further comprising:
establishing in the defined space an AR infrastructure, comprising proximity technology;
identifying the physical object in the defined space for inclusion in a geo-location dependency matrix;
collecting a plurality of physical identifying characteristics associated with the physical object;
determining a logical relationship between the physical object and the other physical objects; and
connecting the physical objects by the determined logical relationships.

9. A computer program product, the computer program product comprising a non-transitory tangible storage device having program code embodied therewith, the program code executable by a processor of a computer to perform a method, the method comprising:
processing a relationship of a physical object to other physical objects in a defined space;
processing a geographical location and orientation of the physical object within the defined space; and
associating an activity with the physical object.

10. The computer program product of claim 9, wherein the physical object comprises metadata, the metadata comprising physical images, schematic references, part descriptors, and interfaces to and between the other physical objects.

11. The computer program product of claim 9, wherein processing the geographic location and orientation of the physical object comprises systematic capture by existing proximity technology to develop integrated physical and logical association maps.

12. The computer program product of claim 11, wherein the proximity technology comprises cameras, RFID tags, QR codes, and augmented reality (AR) devices.

13. The computer program product of claim 11, wherein the associating the activity with the physical object further comprises:
displaying the physical object as an overlay in an AR enabled device;
integrating process steps for performing the activity with the overlay in the AR enabled device:
managing a sequence of the process steps; and
recording a completion of each step.

14. The computer program product of claim 11, wherein an AR enabled device integrates the physical and logical association maps, additional documentation, and a process sequence for an activity as display elements, and wherein each display element is separately selectable.

15. The computer program product of claim 9, further comprising:
upon detecting a presence of an AR enabled device, syncing the AR enabled device with a sync point in the defined space.

16. The computer program product of claim 9, further comprising:
establishing in the defined space an AR infrastructure, comprising proximity technology;
identifying the physical object in the defined space for inclusion in a geo-location dependency matrix;
collecting a plurality of physical identifying characteristics associated with the physical object;
determining a logical relationship between the physical object and the other physical objects; and
connecting the physical objects by the determined logical relationships.

17. A computer system, comprising:
one or more processors;
a memory coupled to at least one of the processors;
a set of computer program instructions stored in the memory and executed by at least one of the processors in order to perform actions of:
processing a relationship of a physical object to other physical objects in a defined space;
processing a geographical location and orientation of the physical object within the defined space; and
associating an activity with the physical object.

18. The computer system of claim 17, wherein the physical object comprises metadata, the metadata comprising physical images, schematic references, part descriptors, and interfaces to and between the other physical objects.

19. The computer system of claim 17, wherein processing the geographic location and orientation of the physical object comprises systematic capture by existing proximity technology to develop integrated physical and logical association maps.

20. The computer system of claim 17, further comprises:
establishing in the defined space an AR infrastructure, comprising proximity technology;
identifying the physical object in the defined space for inclusion in a geo-location dependency matrix;
collecting a plurality of physical identifying characteristics associated with the physical object;
determining a logical relationship between the physical object and the other physical objects; and
connecting the physical objects by the determined logical relationships.
